(19) United States
(12) Patent Application Publication
(10) Pub. No.: US 2026/0161721 A1
(43) Pub. Date: Jun. 11, 2026

(54) Prompt Element Generation for use as Input in Generative Models in a Web Search Environment

(71) Applicant: Google LLC, Mountain View, CA (US)

(72) Inventors: Abhishek Shrivastava, San Jose, CA (US); Hinali Naimish Marfatia, Milpitas, CA (US); Lakshmi Kumar Dabbiru, Santa Clara, CA (US)

(21) Appl. No.: 18/849,404

(22) PCT Filed: Sep. 11, 2023
(86) PCT No.: PCT/US2023/032384

§ 371 Date: Sep. 20, 2024

(51) Int. Cl. G06F 16/9538; G06F 16/9535

(52) U.S. Cl. CPC G06F 16/9538; G06F 16/9535

(57) ABSTRACT

Example embodiments of the present disclosure provide for an example method for validation of output of machine-learned models used in conversational web search systems. The method includes transmitting a search query for retrieving search results including content items. The method can include receiving the search results which can include a first content item associated with a generative machine-learned model with an associated confidence score satisfying a selection criteria. Responsive to receiving the search results the method can include generating a shortcut that, when selected, initiates a conversation interface associated with the first content item. The method can provide the first content item and shortcut. The method can include obtaining input data comprising the selection of the shortcut. Responsive to obtaining the input data, the method includes, initiating a conversation interface associated with the content item and facilitating, using the generative machine-learned model, data transfer associated with the conversation interface.

### FIELD

The present disclosure relates generally to machine learning. More particularly, the present disclosure relates to implementing machine-learned models to facilitate conversational search interfaces.

### BACKGROUND

A computer can execute instructions to generate outputs provided some input(s) according to a parameterized model. The computer can use an evaluation metric to evaluate its performance in generating the output with the model. The computer can update the parameters of the model based on the evaluation metric to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

In one example aspect, the present disclosure provides for an example computer-implemented method. The example computer-implemented method includes transmitting, to a search system, a search query for retrieving search results comprising content items indicating web resources related to the search query. The example computer-implemented method includes receiving, from the search system, the search results. The search results can include a first content item associated with a generative machine-learned model. The machine-learned model having an associated confidence score satisfying a selection criteria. The example computer-implemented method includes generating, responsive to receiving the search results, a shortcut that, when selected, initiates a conversation interface associated with the first content item. The example computer-implemented method includes outputting data comprising instructions that, when executed, cause the interface of a user device to provide for display the first content item and the shortcut. The example computer-implemented method includes obtaining input data comprising the selection of the shortcut. The example computer-implemented method includes, responsive to obtaining the input data, initiating the conversation interface associated with the first content item.

In an example aspect, the present disclosure provides for an example system for prompt element generation for use as input in generative models, including one or more processors and one or more memory devices storing instructions that are executable to cause the one or more processors to perform operations. In some implementations, the one or more memory devices can include one or more transitory or non-transitory computer-readable media storing instructions that are executable to cause the one or more processors to perform operations. In the example system, the operations can include initiating a conversation interface associated with a search session of a web resource search system. In the example system, the operations can include obtaining, via a user interface, input data comprising a query associated with at least one content item provided for display via the conversation interface. In the example system, the operations can include generating, input prompt data comprising the obtained input data and context data associated with the search session. In the example system, the operations can include providing the input prompt data to a generative machine-learned model. In the example system, the operations can include obtaining, from the generative machine-learned model, output data comprising context tailored landing page data and a shortcut indicating a context tailored landing page associated with the context tailored landing page data. The output can be generated based at least in part on the generative machine-learned model parsing a web resource associated with the at least one content item. In the example system, the operations can include validating the output comprising the context tailored landing page data by comparing the output data to the data parsed from the web resource. In the example system, the operations can include providing, responsive to validating the output, via the conversation interface, the output comprising the shortcut.

In an example aspect, the present disclosure provides for an example transitory or non-transitory computer readable medium embodied in a computer-readable storage device and storing instructions that, when executed by a processor, cause the processor to perform operations. In the example transitory or non-transitory computer-readable medium, the operations include transmitting, to a search system, a search query for retrieving search results comprising content items indicating web resources related to the search query. In the example transitory or non-transitory computer-readable medium, the operations include receiving, from the search system, the search results, wherein the search results comprise a first content item associated with a generative machine-learned model, the machine-learned model having an associated confidence score satisfying a selection criteria. In the example transitory or non-transitory computer-readable medium, the operations include generating, responsive to receiving the search results, a shortcut that, when selected, initiates a conversation interface associated with the first content item. In the example transitory or non-transitory computer-readable medium, the operations include outputting, data comprising instructions that, when executed, cause the interface of a user device to provide for display the first content item and the shortcut. In the example transitory or non-transitory computer-readable medium, the operations include obtaining, by the computing system, input data comprising the selection of the shortcut. In the example transitory or non-transitory computer-readable medium, the operations include responsive to obtaining the input data, initiating the conversation interface associated with the first content item.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system to perform validation of output of machine-learned models used in conversational web search systems according to example embodiments of the present disclosure;

FIG. 2 depicts a block diagram of an example system to perform validation of output of machine-learned models used in conversational web search systems according to example embodiments of the present disclosure;

FIG. 3 depicts a block diagram of an example system for training machine-learned models used in conversational web search systems according to example embodiments of the present disclosure;

FIG. 4 depicts an example method for performing validation of output of machine-learned models used in conversational web search systems according to example embodiments of the present disclosure;

FIG. 5 depicts an example method for performing validation of output of machine-learned models used in conversational web search systems according to example embodiments of the present disclosure; and

FIG. 6 depicts a block diagram of an example computing system that performs validation of output of machine-learned models used in conversational web search systems according to example embodiments of the present disclosure.

### DETAILED DESCRIPTION

The present disclosure provides for improved machine-learned models used in conversational web search systems. An example web search system can provide an interface for obtaining search queries and retrieving or displaying results. The search results can include, for example, content items or associated web resources relevant to the search query. The search results can be provided in a conversation interface or a listing of search results. The example system can determine an accuracy of a generative machine-learned model based on an external validation process. In some instances, the generative machine-learned model confidence score can be generated in near-real time or responsive to obtaining a search query (e.g., based on the system's confidence in providing an accurate response to the obtained search query).

The generative model can generate responses to additional queries or generate shortcut elements responsive to the queries. The responses to additional queries can be generated based on the generative model's training on subject-matter or domain specific training data or based in part on parsing a web resource associated with a domain in near-real time to provide up-to-date information.

The generated responses or shortcut elements can be provided for display within the interface in conjunction with the content items or web resources. The generated shortcut element can cause a conversation interface to be initiated or cause a context tailored landing page to be provided for display. In some instances, the conversation interface can be associated with a specific domain of a content item or web resource. For instance, the machine-learned model can parse a specific web resource, or multiple web resources associated with a domain, responsive to obtaining input prompts and generate responses to the prompts based on context data associated with the search session. The system described in the present disclosure can facilitate the transfer of information from a client device associated with a user providing the search queries and the generative machine-learned model. For instance, the system can facilitate the transfer of information via a conversation interface.

In some instances, the system can provide suggested prompts for follow-up queries via the conversation interface. For instance, the generative machine-learned model can generate one or more recommended input prompts (e.g., that the generative machine-learned model “knows” the answer to). In some instances, the conversation interface can include suggested prompts to begin the conversation with the generative machine-learned model powered conversation interface. The suggested prompts can include queries or questions that relate to content on the web resource. For instance, a web resource can be associated with a hair salon and the suggested prompts can include “when can I book an appointment” “what services are available” or “what are the prices of your services?”. The questions that are recommended can be generated by the generative machine-learned model based on content parsed from the content item, a web resource, or a database associated with the content item or web resource (e.g., a domain, a publisher, a content provider).

In some instances, the prompt obtained can be an original prompt (e.g., a natural language question or statement provided by a user in a free-form interface element). In some instances, the system can perform an initial check to determine a confidence level associated with generating a response or can generate a response and then determine a confidence in the accuracy of the response (e.g., via a validation pipeline). The confidence score can be determined by a machine-learned model and can be indicative of a confidence level in the accuracy of the answer being generated and provided as a response. In some instances, the confidence score can be based on a comparison to a parsed web resource, the availability of external validation data, or based on a generated response.

The generative machine-learned model can be trained on information associated with a specific web resource or domain. As such, different web resources or domains can have personalized models or models that have been tuned (or have had some sort of specified or personalized knowledge transfer) to the specific web resource and can determine appropriate suggested prompts. In some instances, the generative machine-learned model can be a single model associated with a number of domains or web resources. As described herein, training can include validating the one or more generative machine-learned models via any reasonable validation process. In some instances, validation can be performed by requiring the generative machine-learned model to provide a “source” for one or more responses. For instance, the generative machine-learned model can provide data indicative of a web resource from which the answer was found as well as a coordinate of the website (e.g., pixel and dimension) associated with the source of the data. This can be used to validate responses in real time. For instance, the system can parse the web resource in real time and compare the content of the web resource at the provided location with the content provided as output from the generative machine-learned model (e.g., via object character recognition (OCR) or other image recognition techniques).

The generative machine-learned model can be tuned to provide improved responses associated with particular web resources. For instance, a party associated with a web resource can provide a custom training dataset upon associating with a content provider. The generative machine-learned model can be trained based on the custom training dataset. The generative machine-learned model can be evaluated (e.g., offline) and has an associated confidence score assigned based on the performance of the model. The generative machine-learned model can be approved to be utilized in a conversational search interface (e.g., the content item can include a shortcut that can initiate the conversation interface).

A technical problem associated with conversational search interfaces is being able to provide a conversational interface that performs similarly to a conversation interface within a web resource itself (e.g., a chatbot on a landing page of a website associated with a particular entity), while not requiring a direct interface with a web resource's conversation interface (e.g., chatbot on the landing page). To provide this solution, the generative machine-learned model that powers the conversational search interface must be tuned with training data associated with the web resource and associated entity. This can allow for interfacing with a customized model associated with a specific web resource in a manner that does not require the web resource to be accessed or loaded in real-time (or near real-time). A generic model could not provide the same correct information or experience as a generative machine-learned model that has been tuned using the custom training data. Further, having separate sets of training data for different entities associated with web resources can allow for training or tuning of the generative machine-learned model(s) in parallel. This provides for technical improvements such as hyper selectivity in generation of responses. Additionally, the present disclosure provides for efficiency in both training the generative machine-learned model(s) and providing efficiencies in generating responses in near real-time via the conversational search interface while providing an experience that is the same as would be experienced via a chatbot on a web resource landing page.

The trained generative machine-learned models can be utilized to provide additional information or resources associated with online resources such as websites, content items, and the like. For instance, the models can be employed in a search context to facilitate “conversations” between a user and a generative machine-learned model (e.g., a language model) tuned for use cases associated with web resources which can be subject to frequent updates.

In some instances, the generative machine-learned models can be trained prior to utilization of the models for conversations with the user. In some instances, the system can determine that not enough historical data or other training data is available for a specific publisher or website. In response, the system can prevent the additional tools from being provided for display to the user. For instance, the tools can include a conversation interface that interacts with a model to generate a context tailored landing page based on prior search or conversational context. Additionally, or alternatively, the model can determine whether an interactive chat interface that is comparable to a live customer service chat should be initiated. The interactive chat interface can be a language model that obtains user input (e.g., queries) and context data as an input prompt and generates responses as output. The system can perform near real-time assessments to determine (1) whether a correct answer can be given with above a certain level of confidence and (2) whether the answer that is given is an accurate answer (e.g., by obtaining explicit user feedback data or inferring user feedback data based on user actions such as exiting out of the chat, terminating the chat, lack of conversion, or other relevant feedback metrics.). The system can automatically assess the model and tune the model or suspend the use of the generative machine-learned model for use in the conversation interface accordingly.

Example aspects of the present disclosure generally relate to machine-learned models for providing responses to queries associated with web resources. For instance, the machine-learned models can be configured to determine a confidence score associated with a likelihood that an accurate response can be generated to the obtained query or obtain user queries and context data as input prompts and generate responses to be provided to a user via a conversation interface associated with a search session. In some instances, the machine-learned models can generate user interface elements that provide shortcuts to additional relevant content responsive to search queries.

An example web search system can provide an interface for inputting search queries and retrieving results. The search results can include, for example, web resources relevant to the search query. The example system can use a machine-learned model to predict confidence score indicative of a likelihood that an accurate response can be generated to the obtained query or obtain user queries. The system can, in response to determining that the confidence score satisfies a criterion, generate a shortcut element that upon selection, causes a conversation interface to initiate. The conversation interface can obtain additional user input (e.g., selection of a recommended prompt, input of natural language queries) and, using a machine-learned model, generate responses to the obtained user input via the conversation interface. In some instances, the machine-learned model can determine that an accurate response cannot be generated based on parsing a web resource associated with the conversation interface. In response, the system can provide a message indicating that an accurate response cannot be provided and provide shortcuts to a web resource that can contain additional information related to the query or a destination for a relevant action to perform with a web resource in the search results. Based on the predicted relevant action, the example system can generate a shortcut element for presenting on the interface in conjunction with the web resource to enable direct loading of a conversation interface for providing follow-up responses to follow-up queries. In some instances, the destination for the shortcut can be another web resource configured for answering the query (e.g., a related page of a website). The destination can include a resource locator (e.g., a URL) to the other web resource. The shortcut element can include a hyperlink that initiates loading of the web resource indicated by the resource locator.

For example, a user can use a client device to enter a search query into a search engine interface of an application (e.g., using a browser application). An example search query is “hair salons.” The search engine can process the query to generate a list of search results. The search results can be web resources (e.g., web pages, web applications, etc.). For instance, the search results can include web pages or applications associated with hairstylists, barbers, or other cosmetology providers. The search engine can return the list of search results to display to the user. An additional example can include a user looking for information about buying a new car. A few example follow-up queries relating to a content time associated with a new car for purchase can include: “What is the base price of this car?”, “What are the features of this car?”, “What are the reviews of this car?”, “What is the fuel efficiency of this car?”, “What is the safety rating of this car?”, “What are the colors that this car comes in?”, “What are the different trim levels of this car?”, “What are the financing options available for this car?”, or “What are the trade-in options available for this car?” These are example queries that can be responded to by the generative model based on parsing the landing page or other web pages of a web resource associated with the content item.

The application can receive the search results and customize an interface for presenting the list based on user context. The application can use a machine-learned action prediction model to determine a likelihood that follow-up queries can be accurately answered based on a prediction of potential follow-up queries and data obtained by parsing a web resource associated with one or more of the listings of web resources. For example, the application can determine that a user is looking for a web resource to aid the user in booking an appointment at a hair salon.

A generative machine-learned model can be utilized to power the conversation interface. The generative machine-learned model can be tuned or trained based on the particular web resource to provide answers that are (1) accurate and (2) align with the look or feel of the web resource. For instance, the conversation interface can be configured in a similar color scheme to the web resource or can use language obtained from customer service manual for responding to certain queries. In a sense, the generative machine-learned model (e.g., a conversation model) can be tuned to answer questions relating to the specific publisher or company associated with the resource to provide an experience similar to chatting with a live customer service representative.

In some implementations, a shortcut can be provided responsive to a query. For instance, the shortcut can have a destination associated with a web resource. The destination associated with the web resource can include a sub domain of the web resource. The destination associated with the web resource can be a context tailored landing page.

The context tailored landing page can be generated by a generative machine-learned model. In some instances, instead of initiating a chat interface, the original shortcut generated can cause a custom landing page to be generated based on the most recent query and context data associated with the search session. For instance, the generative machine-learned model can obtain an input prompt and output the custom landing page and a shortcut having a destination of the custom landing page.

Additionally, or alternatively, the computing system can validate the output. For instance, the computing system can include a feedback loop that takes the output (e.g., conversation interface responses to queries, context tailored landing page) and compares it to a ground truth. Machine-learned models can be trained, tuned, or updated to provide more accurate results. In some implementations, validation can be performed in near-real time. For instance, the computing system can compare the output to a web resource associated with the responses to a ground truth such as an existing data structure, data obtained from parsing the web resource, or user-generated data. The system can determine a confidence score associated with the likelihood that the output is accurate, and responsive to the confidence score satisfying a selection criterion, the output can be provided for display to a user. If, however, the confidence score does not satisfy the selection criteria, the computing system can provide for display a general message indicating that the user can visit the web resource for additional information or provide contact information for a resource to provide accurate responses to the obtained queries.

The technology of the present disclosure can provide a number of technical effects and benefits. For instance, aspects of the described technology can allow for a reduction in the number of calls made to the generative models by generating higher quality output responsive to the context data and prompts input into the machine-learned models.

Additionally, the technology of the present disclosure can provide for a feedback loop for training machine-learned models. For instance, model trainers or validators can utilize the output obtained by the conversational machine-learned models and continually train the model to generate better (e.g., more relevant) output.

In some instances, prompt elements can be recommended. By recommending prompt elements to a user, the system can reduce processing and errors from incomplete or incorrect prompts. Prompt engineering can be a difficult task and determining the proper prompt to input into a generative model to get out an image or other output that is satisfactory can result in iterative calls to the generative models which can waste processing resources and bandwidth due to redundant calls to the models. The present disclosure can predict an intent of a user based on the initial prompt and context data and can provide suggested prompt elements based on the initial prompt, context data, or additional selection criteria.

Additionally, by training and updating the models (e.g., language models, machine learning models, large language models) using a feedback loop, the models can be continually fine-tuned and trained to produce better suggested prompt elements. This can additionally reduce the number of updated prompts a user provides as well as reduce the number of calls made to the image generation model.

The improvements associated with the systems and methods discussed herein can be further understood with reference to the figures.

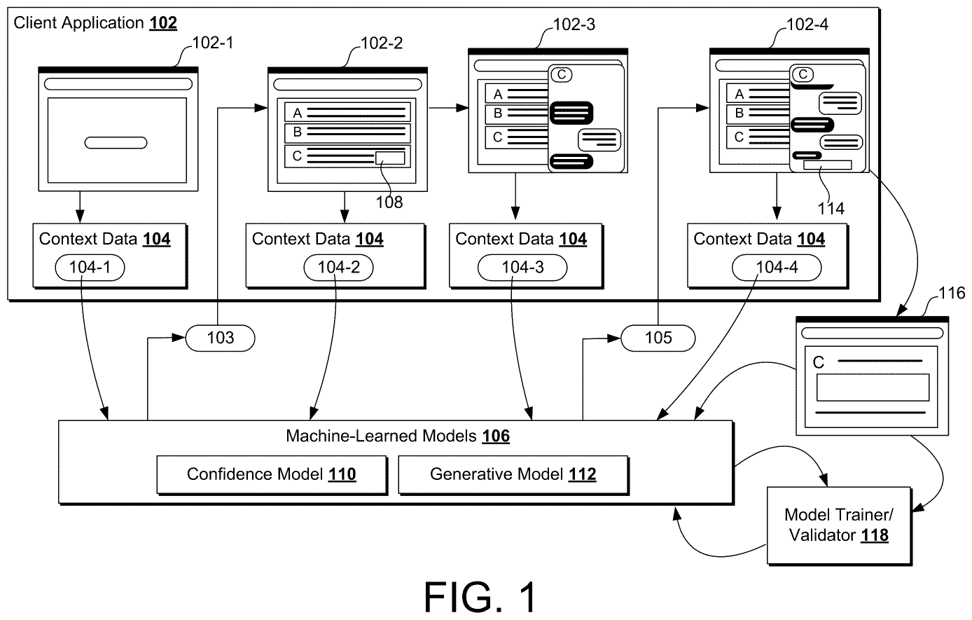

Reference now is made to the figures, which provide example arrangements of computing systems, model structures, and data flows for illustration purposes only. FIG. 1 illustrates an example conversational generation system according to the present disclosure. A client device can implement a client application 102 (e.g., a browser). Client application 102 can maintain a set of context data 104 which can maintain a trace of recent actions taken in client application 102. Client application 102 can provide a first interface for submitting a search query as depicted by client application state 102-1. One or more action indicators 104-1 can represent aspects of this first action. Client application 102 can process a search query and present a list of search results. Action indicators 104-1 can include indications of prior searches, initiation of a new search, or other actions. Based on one or more action indicators in context data 104, one or more content items can be selected to be presented alongside the list of search results.

For instance, the computing system can perform a content selection process to select one or more content items to be provided for display with the list of search results. The content items can be selected based on the search query, context data 104, or one or more action indicators 104-1. The content selection pipeline can generate output data 103.

In some instances, an additional or alternative selection criteria for the content items can include a confidence score associated with the respective content item. In some instances, a content item confidence score can be generated and stored to be utilized at content selection time. Additionally, or alternatively, the confidence score can be generated in near-real time.

For instance, a machine-learned confidence model 110 can generate a confidence score associated with a probability that the machine-learned models 106 can initiate and facilitate a conversation providing accurate responses to input prompts (e.g., have a customer service-like conversation by obtaining input queries and generating responses). Responsive to determining that the confidence score generated by confidence model 110 satisfies a selection criterion, the system can generate output data 103.

Output data 103 can include data comprising instructions that, when executed by a computing device, cause a content item or a shortcut to be depicted as a selectable shortcut interface element 108 as depicted in client application state 102-2. The shortcut can include an additional selectable shortcut interface element 108 for client application 102 to render alongside a content item via client application state 102-2. Client application state 102-3 can include rendering the additional selectable shortcut interface element 108 within the search results page. For instance, the search results page can include a native search result (e.g., search result A), and a content item (e.g., content item C). The search results can be selected responsive to the initial user query. Additionally, a content selection component associated with the system can select a content item to be displayed based on various selection criteria. In some instances, the selection can include a bidding process. In some instances, the selection criteria can include the confidence score associated with a generative model that is associated with the content item and associated web resource.

For example, the web resource returned in the search results can be a web homepage for a car dealership, www.FictionalCarDealer.com. The application can determine that a generative model trained on Fictional Car Dealer data performs at an accuracy level that satisfies the selection criteria. As such, the application can determine that a conversation interface can be initiated to provide additional responses to user queries relating to www.FictionalCarDealer.com. Thus, in addition to returning a content element including a hyperlink to www.FictionalCarDealer.com in the search results, the client application 102 can render a selectable shortcut interface element 108 that upon selection, automatically updates the user interface to initiate the conversation interface (e.g., as depicted in client application state 102-3).

The system can determine that a user has selected the selectable shortcut interface element 108. Responsive to determining that the selectable shortcut interface element 108 has been selected, the user interface of client application 102 can be updated to client application state 102-3. Client application state 102-3 can include an interactive conversation interface. The system can obtain user input comprising a follow-up query and can facilitate a data transfer between the client application 102 and the machine-learned models 106.

Machine-learned models 106 can obtain context data 104 which can include action indicators 104-2. Context data 104 can include data associated with a current search session, data used to train the generative model 112, publisher data, third-party content provider data, data obtained from a crawl via online search (e.g., parsing web resources, parsing a knowledge graph associated with the search engine). Context data 104 can be obtained from one or more locations. Context data 104 can be updated on a regular (e.g., a set increment of time) or irregular basis (e.g., responsive to obtaining a search query). Context data can include action indicators 104-3.

Context data 104 can be used for prompt engineering. For instance, the computing system can obtain a follow-up search query, action indicators 104-3 or other context data 104.

The computing system can obtain the data which was received via the interactive conversation interface depicted by client application state 102-3. The prompt engineering can include obtaining the follow-up search query, action indicators 104-3, or other context data 104 and generating a data structure comprising a prompt to be provided as input for machine-learned models 106. For instance, the generated prompt can be provided as input into generative model 112. The generative model 112 can generate an output 105.

Output 105 can generate or edit manually provided search queries or follow-up queries to more efficiently utilize computing resources by generating an input prompt data structure that efficiently conveys the context of the conversation (e.g., as described herein). In some instances, input prompts can be pre-generated prompts or prompts containing select pre-generated portions (e.g., a template that substitutes in personalized information about previous queries, goal of performing the search, or other context data). In some instances, the obtained user query can be a pre-generated or suggested query. For instance, the system can provide suggested questions that are parsed from a “Frequently Asked Questions” subdomain of a web resource. Other common questions, or questions that the generative model 112 can confidently answer can be provided as suggested follow-up queries.

Machine-learned models 106 can include generative model 112. The system can obtain a most recent query and context data 104 (e.g., including action indicators 104-2) as input, and in response, generate output. The output 105 can cause the state of client application 102 to update to client application state 102-4. Client application state 102-4 can include one or more responses to the user queries obtained during client application state 102-3. Additionally, or alternatively, client application state 102-4 can include a selectable user interface element 114. The selectable user interface element 114 can include, for example, a shortcut to web resource 116. The system can transmit context data 104 associated with client application state 102-4. For instance, context data 104 can include action indicators 104-4.

The generative model 112 can generate the shortcut or one or more responses to user queries based on context data 104. For example, the context data can include the search query, prior search queries, other web resources loaded by the application, state or usage data from the client device, account data associated with a user account of the user, etc. The context data can be retrieved from a cache or storage on the client device or retrieved (e.g., periodically, in real time) from secure storage on a cloud storage server (e.g., associated with a user account of the user).

The generative model 112 can be implemented on-device or in the cloud. In on-device implementations, for example, context data cached on the device can be input to the machine-learned model. In this manner, for instance, additional communications with a cloud server can be avoided, decreasing latency and increasing security of the context data (e.g., by avoiding additional transmissions of the context data over a network, etc.).

The generative model 112 can be a lightweight model configured to operate on hardware with limited processing resources (e.g., limited processing bandwidth or speed, limited battery capacity, limited memory, etc.). The generative model 112 can be trained specifically for generating responses to queries associated with a particular web resource, publisher, or other third party. The generative model 112 can be trained to generate responses to queries or to directly output a resource locator for a web resource (e.g., landing page). For instance, generative model 112 can be trained by model trainer/validator 118.

The generative model 112 can be a sequence-to-sequence model configured to receive a sequence of prior actions, queries, or responses (e.g., current or preceding “conversations” with the conversation interface, current or preceding resource locators of the user's journey) and generate a next response (e.g., a response to a query, an answer to a question, a next resource locator). The machine-learned action prediction model can be or include a transformer architecture (e.g., encoder-decoder, encoder only, decoder only, etc.).

The generative model 112 can be trained by model trainer/validator 118 on a corpus of action sequences or conversations to learn to predict likely next queries and generate responses. The corpus of action sequences or conversations can be obtained by collecting, from a number of participating client devices, sequences of action sequences or conversations performed in a user journey. For instance, a user journey can include a search on a search engine, a follow-up query, a follow-up response providing an answer relating to the query, a second query, and a second response, and an indication of a user satisfaction with the response. This sequence of actions can be cached on participating client devices, stripped of any personal identifiers, and uploaded to a training server associated with model trainer/validator 118 to be a training example for training the generative model 112.

The sequence of actions or conversation can include a sequence of resource locators, queries, or responses. The resource locators, queries, or responses can be tokenized and embedded into learned vector representations. The resource locators, queries, responses or representations thereof can be input to the generative model 112 for processing. The generative model 112 can generate responses by outputting one or more values or tokens corresponding to an answer (e.g., one or more tokens corresponding to a natural language response to the query, a probability associated with a likelihood that the natural language response is correct, etc.) to the obtained user query or corresponding to the destination resource locator (e.g., one or more tokens corresponding to the resource locator, a probability associated with one or more vocabulary entries associated with the resource locator, etc.).

At inference time, the generative model 112 can generate the response based on context data 104. Context data 104 can include one or more contemporaneous or prior queries, responses, or actions (e.g., an action sequence containing one or multiple actions). The context data can include sensor data from the client device. The context data can include cached or logged data describing a usage history of the client device. The context data can be tokenized and input to the generative model 112 to generate the next response.

Further the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as city, ZIP code, or state level), so that a particular location of a user cannot be determined. Thus, the user may have control over what information is collected about the user, how that information is used, and what information is provided to the user.

Example techniques of the present disclosure can provide a number of technical effects and benefits. A technical effect of example implementations of the present disclosure is decreased network transmissions. Retrieving web search results on a client device from a search system can involve transmitting and receiving data over a network connection. Each new web resource loaded generally requires additional data transmitted from a server hosting the web resource to the client device. By providing search results augmented by a conversation interface to generate responses to queries (e.g., answers to questions), a computing system according to the present disclosure can provide a more direct path to the relevant responses (e.g., by preventing a web resource from being loaded in order for a user to find relevant information). By initiating a conversation interface based on context data and a most recent query, the system as a whole can decrease a number of required page loads for answering the most common queries. In this manner, for instance, the most common queries, and in some instances, new queries experienced by the system (e.g., the web servers, networking systems, network infrastructure, etc.) can be responded to with decreased number of web resource/page loads.

Decreasing a number of separate web resource/page loads when providing relevant information via a user interface can decrease the amount of data transmitted over the network. This can decrease total bandwidth utilization of the network or allow for a greater number of users to be served within the same data budget. Decreasing a number of separate web resources/pages that the user loads to access information (e.g., content from a content provider, publisher, or third-party) can decrease a number of processing cycles executed by the client device or server system. Decreased processing cycles can provide for more efficient energy use, prolonging operation in energy-constrained environments (e.g., battery-powered client devices). Decreased processing cycles can provide for lower power usage. Decreasing a number of separate web resources/pages that the user loads to access an action interface can decrease the memory allocation required for maintaining a browser. Decreased memory usage can provide for lower power usage.

In this manner, for instance, the improved energy efficiency of example implementations of the present disclosure can reduce an amount of pollution or other waste, thereby advancing the field of network-connected computing systems as a whole. The amount of pollution can be reduced in total (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. The amount of heat pollution in an environment (e.g., by the processors/storage locations) can be reduced by implementing more energy-efficient training or inference operations.

Generative model 112 can obtain additional context data 104, action indicators 104-3, and query data obtained via client application 102 (e.g., via the system facilitating the data transfer between client application 102 and the machine-learned models 106). Generative model 112 can obtain the query and context data 104 and generate output data 105. In some instances, output data 105 can be generated based on data parsed from a web resource associated with the content provider, publisher, or third-party. The output data 105 can be provided for display via the conversation interface (e.g., at client application state 102-4) of client application 102. Obtaining additional queries, generating input prompts, transmitting the input prompts to the machine-learned model, obtaining output from the machine-learned model and updating the conversation interface can be performed a number of time (e.g., as a feedback loop) for a number of additional queries obtained by the system. In some implementations, the conversation session can be summarized into a compact data structure (e.g., action indicator 104-3). For instance, the data structure can include a number of tokens that represent certain words or portions of words.

Generative model 112 can additionally ingest data from a publisher platform indicative of real-time data associated with a publisher or third party associated with a content item or web resource. For instance, certain services or products can be available in only specific geographies (e.g., geographically tailored items, sales running in certain areas but not others, etc.). A content provider or publisher can maintain a database of information associated with the publishers or third parties to supplement any data that is available from parsing a web resource (e.g., web resource 116). This data can be updated multiple times a day and the generative model 112 can be provided updated data multiple times a day.

The system can facilitate data transfer between client application 102 and machine-learned models 106. For instance, the system can provide the obtained context data 104 as input to generative model 112 to generate output data 105. Output data 105 can include a shortcut to the destination web resource 116. The shortcut can include a selectable user interface element 114 for client application 102 to render via client application state 102-4. Client application state 102-4 can include rendering the selectable user interface element 114 within the conversation interface. For instance, the web resource returned in the search results can be a web homepage for a car dealership, www.FictionalCarDealer.com.

Selectable user interface element 114 can include a hyperlink to web resource 116. Web resource 116 can be parsed in near real-time to determine responses to queries, can be parsed ahead of time and responses cached, can be used by model trainer 118 to train machine-learned models 106, or can be launched/opened from selectable user interface element 114 (e.g., a shortcut) provided via the conversation interface (e.g., at client application state 102-4).

Model trainer 118 can use a variety of training data. Training data can include user feedback data, custom generated training data sets, or other training data. Training data can include baseline training data. The baseline training data can include one or more landing pages associated with a web resource, a crawled web resource, or other known or ingested data. The training datasets can be generated upon a publisher or third-party's onboarding to the search results service. For instance, the system can update the training data on a recurrent basis, such as daily or weekly. Additionally, or alternatively, the training data can be updated on a sporadic basis based on newly obtained data or other trigger events.

For instance, custom generated training data sets can be generated based on performing a recognition process on the parsed web resource to generate a data structure including both text and a location of text within the web resource. The output of the model can include a source for any text that is generated. For instance, the data structure can include “sale now to Month and Day” located at Pixel 200. Model trainer 118 can request that the generative models 106 provide the source of the response to the user's query (e.g., came from a data store, a location on a parsed website). If the text is not found on the original web resource (or additional data associated with a publisher or third-party content provider), the model trainer 118 can parse the web resource to determine what is located at that location of the web resource. As such, the system can determine when a hallucination has taken place or can otherwise validate the output generated by the machine-learned models. In some instances, this validation can be performed in real-time or near-real time. In some instances, this validation can be performed after a search session has concluded.

The generated training data can include example questions and ground-truth answers that are provided as input into the generative model. Responsive to obtaining the training data set, the system can train the models 106 by providing input including a query. The generative model 112 can be trained by continuously processing the input queries, generating output, and performing a comparison of the output to the predicted output associated with the training data. In some instances, the queries can be generated by an additional generative machine-learned model. The generative machine-learned model can be a language model. In some implementations, the generated questions can include one or more personalized suggestions.

In some instances, the training data can be data obtained from an administrator-provided input. For instance, the administrator-provided input can include a customer service handbook associated with the web resource (e.g., a customer service handbook associated with a specific store). This training data can be ingested and utilized by model trainer/validator 118 to tune the model to facilitate a conversation with a similar look and feel to a landing page or accurate data based on content of location data. This can allow for a generative model (e.g., language model, conversational mode), to provide for more domain-specific interactions compared to a “one-size fits all” general model.

In some instances, the machine-learned models 106 can be trained on data obtained from a publisher database. For instance, the publisher can have data relating to certain content campaigns including subject matter or campaign parameters. In some instances, machine-learned models 106 can be trained based on the publisher data using a precision recall loss analysis. If the model is determined to perform at a satisfactory rate (e.g., a criterion that can be selected or set by an industry standard, user input, or other selection criteria), then the system can determine that it is appropriate to provide a selectable shortcut (e.g., button to “ask more”) to launch the conversation interface. In some instances, a model can have no strong signal of web resource or third-party's history with a publisher. As such, the content item associated with the web resource or third-party can be presented without a generated shortcut (e.g., button to “ask more”).

In some instances, when the conversation interface is initiated, the conversation interface can provide suggested follow-up queries. For instance, the suggested follow-up queries can be generated prompts that the generative model 112 can provide known answers to. For instance, common questions for a pet food supplier can be “how long is the shelf life,” “is the food approved by the FDA?” or other common questions. Additionally, or alternatively, a user can provide a custom input query (e.g., a manual prompt). In some instances, the generative model can determine that there is an uncertainty in the accuracy of a generated answer (or inability to generate an answer). In response, the model can generate a response indicating that an answer cannot be provided, and the web resource should be reviewed for the answer to the query. Additionally, or alternatively, the model can provide a shortcut that has a destination of the web resource associated with the initial content item that was provided as a search result content item.

Context data 104 can be obtained by the machine-learned models 106 and be used by the model trainer/validator 118 to allow the machine-learned models 106 to be improved for future use.

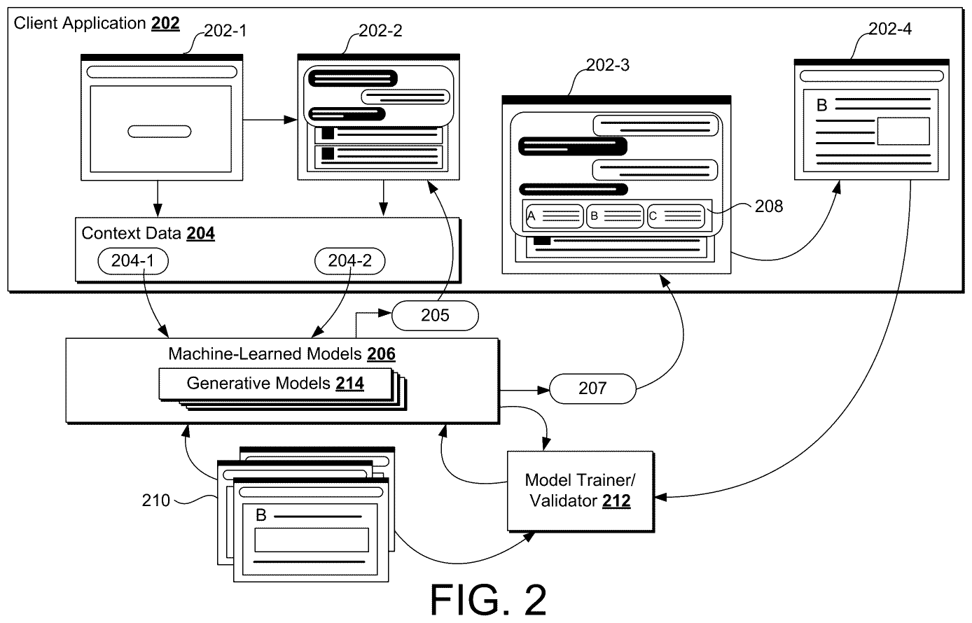

FIG. 2 illustrates an example context tailored landing page generation system according to the present disclosure. A client device can implement a client application 202 (e.g., a browser). Client application 202 can maintain a set of context data 204 which can maintain a trace of recent actions taken in client application 202. Client application 202 can provide a first interface for submitting a search query. One or more action indicators 204-1 can represent aspects of this first action. Client application 202 can process a search query and present a list of search results. Action indicators 204-1 can include indications of prior searches, initiation of a new search, or other actions. Responsive to receipt of a search query, client application 202 can update from application state 202-1 to application state 202-2. Application state 202-2 can include a conversational search interface. The conversational search interface can obtain user input queries which can be transmitted and used as input into machine-learned model. For instance, the queries can be provided alongside context data 204, such as action indicators 204-1 to be used as input into the machine-learned models 106. In some instances, the system can generate prompts based on the search query data, context data 204, or action indicators 204-1. The system can facilitate data transfer between the client application 202 and the machine-learned models 206. Thus, the conversational search interface can provide answers to user's questions, provide recommendations for further search terms, ask questions about what the user is searching for, or otherwise facilitate providing better search results.

Context data 204 can facilitate generating context tailored landing pages or shortcuts by providing generative models 214 with relevant cues for generating context tailored landing pages that emphasize information related to the user search session journey (e.g., various queries and responses, context data, and the like) and outputting a corresponding resource locator for linking to an interface for providing the context tailored landing page for display. Context data 204 can include current or past state data of the device executing client application 202. State data can include location data, sensor data (e.g., temperature, inertial, photonic, etc.). Context data 204 can include current or past application data (e.g., client application 202), including application logs or traces. Context data 204 can include a sequence of one or more actions performed using the application. For instance, context data 204 can include a sequence of one or more resource locators of resources presented via client application 202.

For instance, action indicator(s) 204-1 can represent an action associated with application state 202-1. The action indicator 204-1 can represent a resource locator associated with a search action. The action indicator 204-1 can be or include an embedded value. For instance, a resource locator can be processed by one or more tokenizing or embedding layers of a machine-learned model to generate action indicator 204-1 representing the action associated with the resource locator. Action indicator(s) 204-1 can include a single token corresponding to the resource locator (e.g., a word-level token with the resource locator as one “word”). Action indicator(s) 204-1 can include multiple tokens corresponding to the resource locator (e.g., multiple subword-level tokens with the resource locator being a “word” composed of multiple component subwords).

Other context data 204 can be embedded with the resource locator. For instance, additional dimensions can be added to the embedding vector to represent an embedding of the context data. Context data can be embedded directly with the resource locator in the same vector.

Action indicator(s) 204-2 can represent an action associated with application state 202-2. The action indicator 204-2 can represent a resource locator associated with a search result or search result listing. The action indicator 204-2 can be or include an embedded value. For instance, a resource locator can be processed by one or more tokenizing or embedding layers of a machine-learned model to generate action indicator 204-2 representing the action associated with the resource locator. Action indicator(s) 204-2 can include a single token corresponding to the resource locator (e.g., a word-level token with the resource locator as one “word”). Action indicator(s) 204-2 can include multiple tokens corresponding to the resource locator (e.g., multiple subword-level tokens with the resource locator being a “word” composed of multiple component subwords).

Other context data 204 can be embedded with the resource locator. For instance, additional dimensions can be added to the embedding vector to represent an embedding of the context data. Context data can be embedded directly with the resource locator in the same vector.

Action indicator(s) 204-2 can be associated with a web resource listing search results. Action indicator(s) 204-2 can be associated with one or more of the search results. Action indicator(s) 204-2 can represent a resource locator of a search result.

An action or data descriptive of an action (e.g., action indicator 204-1, 204-2, etc.) can include data in a format of [Action name, Action URL, Suggestive data elements]. The data can be rearranged or omitted as desired. Other data can be included. Other formats can be used.

Machine-learned models 206 can include one or more generative models 214. For instance, generative models 214 can include a conversation generation model or a landing page generation model. Generative machine-learned models 214 can obtain context data 204 and web resource data parsed from web resources 210 to generate output data 205-1 or output data 207. Output data 205 can include responses to queries obtained via the conversational search interface.

The generative machine-learned models 214 (e.g., a conversation model) can obtain context data 204 including the action indicators 204-1 as input. In some implementations, the context data 204 can be transmitted to the machine-learned models 206 which can generate output data 205 and output data 207. Output data 207 can be transmitted to a domain associated with a web resource. For instance, output data 207 can include contextual data which can be transmitted via an HTTPS request. The domain associated with the web resource can generate a customized (e.g., context tailored) landing page based on the output data 207. In some instances, the domain can revert a shortcut, such as a URL, to the custom landing page which can be incorporated within the one or more content items 208.

Context data 204 can include action indicators 204-2. Context data 204 can include, for instance, a query context, prior generative machine-learned model (e.g., a conversation model) responses, and generative machine-learned model (e.g., a conversation model) verification with third-party web resources. The action indicators 204-2 can be provided as a prompt input into one or more generative models 214 (e.g., a landing page generation model). The action indicator 204-2 can be provided in any format. For instance, the action indicator 204-2 (e.g., context payload) can include a prompt message in a conversational user dialog fashion. For example, an action indicator 204-2 associated with a search session for fast internet can include the following:

```
{
  “interests”: “fastest broadband internet”,
  “geo”: <device_location>
  “exclusions”: “tv bundle, ott services”
}
```

For instance, the prior queries and responses associated with application state 202-1 and application state 202-2 can include context of the device location, terms related to a user intent (e.g., looking for fast broadband internet, not looking for a tv bundle or over-the-top (OTT) services). As such, the system can generate a summary of the contextual data to be used as an input prompt to the machine-learned models 106.

The action indicators 204-2 can include a new payload including the context data. The context data can include information relating to the initial query or prompt alongside other context data 204. The context data can, for example, be a JSON format of <token,value> pairs. As described herein, the processes described can be performed with end-to-end encryption or encoding as well as removal of any personally identifiable information (PII).

The generative models 214 (e.g., a context tailored landing page generation model) can be associated with a domain of a web resource or a third-party. The generative models 214 can obtain the context data 204 (e.g., via an HTTPS request), and, in response, generate the context tailored landing page or a data comprising instructions that, when executed, cause a context tailored landing page to render via client application 202 (e.g., at application state 202-4).

Output data 207 can include data comprising one or more content items with associated interface input elements. In some instances, output data 207 can be data associated with a shortcut to a context tailored landing page as depicted in client application state 202-4.

As described herein, a landing page generation model of the generative models 214 can obtain context data 204 and web resource data 210 to generate custom landing pages. In some instances, the conversation search interface can include a presentation of one or more content items 208 associated with one or more web resources 210. The content items 208 can be generated based on web resource data 210. The content items 208 can be generated in near real-time by a machine-learned model of machine-learned models 206. In some instances, the content items 208 can be pre-generated. At least one content item of content items 208 can include a shortcut that has a destination of a context tailored landing page. An example context tailored landing page is depicted by application state 202-4.

Content items 208 can include a plurality of selectable content items. In some instances, content items 208 can include one or more search results with shortcuts containing uniform resource locators (URLs) to various web resources. In some instances, content items 208 can include advertisements or other generated content that is selected and provided based on context data 204 and a most recent query data. Context data 204 can be generated by the system. In some instances, the system can transmit context data 204 via an HTTPS or other mechanism (e.g., based on payload). The system can adjust a landing page based on the context data 204 or query data. In some instances, the computing system can determine whether the output data 207 obtained from the landing page generation model 216 is accurate or contains hallucinations (e.g., or a context tailored landing page cannot be generated or displayed).

Content items 208 can include previews for the one or more context tailored landing pages. For instance, the data associated with the content item 208 can be generated and determined at a time before the conversation interface is initiated. The system can crawl, index, and store the machine-learned model generated landing pages. These stored generated landing pages can be displayed within the content items 208. This can provide for a preview of relevant content information that can allow a user to read a preview and determine whether to select the shortcut to cause the context tailored landing page to be displayed (e.g., at client application state 202-4). The preview can help prevent unnecessary system calls for landing pages that will ultimately be considered irrelevant (e.g., adding to the processing that will occur by generating one or more additional requests for context tailored landing pages).

The present disclosure can be utilized in conjunction with a plurality of systems. One such system can allow for the indexing of web resources associated with a search query and generating summary previews for each relevant web resource. This can provide for more efficient utilization of computing resources by decreasing bandwidth usage associated with opening a plurality of web resources.

As described herein, landing page generation model of generative models 214 can generate output data 207 comprising a shortcut and destination data. The shortcut's destination data can include data that causes client application 202 to update from application state 202-3 to application state 202-4. Application state 202-4 can include the rendering of the context tailored landing page. The context tailored landing page can include information tailored to the context data 204 obtained from the search session.

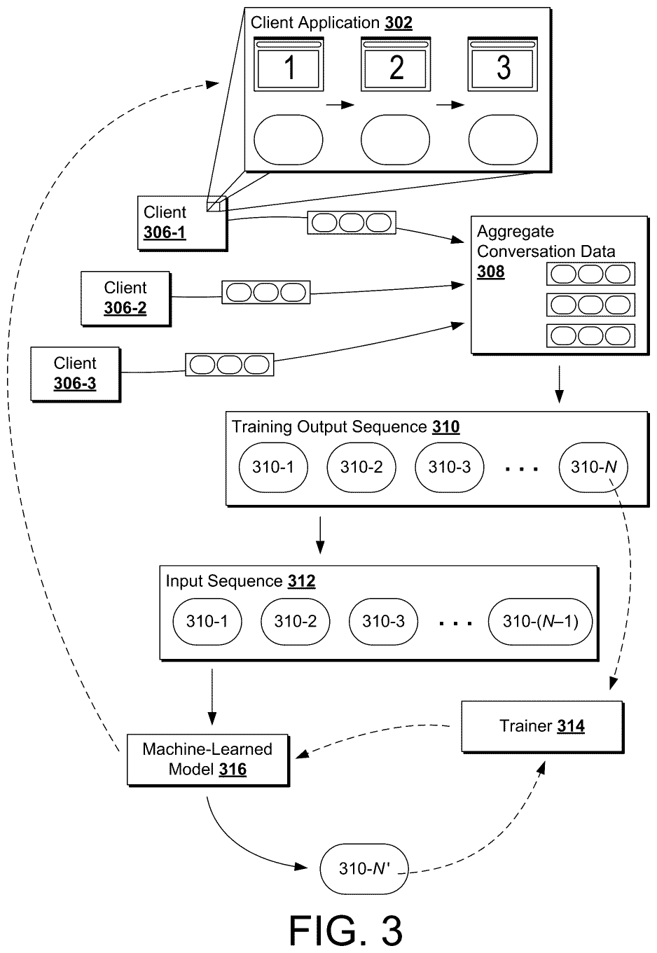

Additionally, or alternatively, the generative models 214 (e.g., a landing page generation model) can populate an existing landing page generator template. In some instances, the data associated with the context tailored landing page can be provided as input to the model trainer/validator 212. The model trainer/validator 212 can determine the accuracy of the data associated with the context tailored landing page (e.g., as described further with regard to FIG. 3). Model trainer/validator 212 can train or tune machine-learned models 206 based on the context tailored landing page, existing web resources 210, or other obtained feedback data. The machine-learned models 206 can be continually trained or tuned using a feedback loop to continually adjust parameters and improve model performance.

Additionally, or alternatively, the system can generate a prompt to obtain user input relating to the quality of the context tailored landing page. For instance, a user can provide responses to a survey about the landing page, whether the landing page provided relevant information or context, evaluation of the landing page quality, or the user prompt information and context data used for generating the context tailored landing page.

In some instances, the system can further provide a shortcut to a context tailored landing page as part of content items 208. The system can infer performance of the conversation interface based on one or more obtained metrics. For example, the system can obtain data indicative of click quality, long clicks, short clicks, etc. for one or more context tailored landing pages. A longer click to short click ratio can be indicative of a user spending a longer amount of time on the context tailored landing page. The system can infer that the longer amount of time can be indicative of the content being more relevant to the user query and can prevent the user from providing follow-up queries which would utilize additional bandwidth and computing resources.

Additionally, or alternatively, the system can use additional metrics such as bounce rate, conversion rate, time on page, or pages per session to determine a relevance or utility of the context tailored landing page. Bounce rate can include a percentage of users that exit from the landing page after viewing the initial landing page (e.g., indicating the landing page is irrelevant or poorly designed). Conversion rate can indicate a percentage of users who perform a desired action on a landing page. The action can include, for example, signing up for a newsletter, visiting a certain portion of the web resource, adding an item to a cart, making a purchase, and the like. Higher percentage of conversion rate can be indicative of a better performing context tailored landing page. Time on page can indicate an average amount of time that a user spends on a landing page (e.g., higher time being indicative of the content being interesting and engaging). Pages per session can include an indication of an average number of pages viewed during a session. A high pages per session metric can indicate a relevant context tailored landing page (e.g. more useful or relevant content being provided).

FIG. 3 illustrates an example training technique for training a machine-learned model (e.g., confidence model 110, generative model 112, generative models 214). A plurality of clients 306-1, 306-2, and 306-3 can execute a client application 302 (e.g., client application 102 or 202). The clients can use client application 302 (e.g., client application 102 or 202) to load to initiate loading of various resources, such as web resources (e.g., using URLs) or native applications (e.g., using deep links). Client application 302 (e.g., client application 102 or 202) can log conversations in sequences in which the various resources are loaded or can log common query-response pairings. The client devices 306-1, 306-2, 306-3 can privatize (e.g., noise, strip PII, etc.) and upload this log data to a server to form aggregate conversation data 308. Aggregate conversation data 308 can contain training conversation sequence 310 containing conversation indicators 310-1, 310-2, 310-3, . . . , 310-N. Drawn from training conversation sequence 310, input sequence 312 can contain conversation indicators 310-1, 310-2, 310-3, . . . , 310-(N−1), with the subsequent conversation indicator 310-N omitted. Machine-learned model 316 (e.g., generative models 112 or 214) can process input sequence 312 to generate a predicted conversation indicator 310-N′. Trainer 314 can evaluate how well predicted conversation indicator 310-N′ aligns with ground truth conversation indicator 310-N. Trainer 314 can initiate updates to one or more learnable parameters of machine-learned model 316 (e.g., generative model 112 or 214). A computing system can distribute updated machine-learned model (e.g., generative model 112 or 214) to one or more client devices, such as clients 306-1, 306-3, 306-3, although it is to be understood that aggregate conversation data 308 can include data obtained from clients that do not implement machine-learned model (e.g., generative model 112 or 214).

Clients 306-1, 306-2, 306-3 can be or include one or more computing devices. Clients 306-1, 306-2, 306-3 can each implement a version of client application 302 (e.g., client application 102 or 202). Clients 306-1, 306-2, 306-3 can use client application 302 (e.g., client application 102 or 202) to navigate from one web resource to another. Client application 302 (e.g., client application 102 or 202) can generate log data tracing a sequence of query-response pairs or web resources. The log data can include conversation indicators for each loaded resource. The conversation indicators can include a resource locator for the loaded resource. The log data can include sequences of resource locators. The log data can include other context data.

Client application 302 (e.g., client application 102 or 202) can detect, when processing web resources, a request to not be logged. For instance, some web resource owners or publishers can wish to decline participation in the conversation sequence logging. These entities can add, to the web resource or query-response pair, data indicating a request to not participate. Client application 302 (e.g., client application 102 or 202) can omit such web resources from the log data. Client application 302 (e.g., client application 102 or 202) can terminate a logged sequence with the preceding web resource and initiate a new logged sequence with the next permitted web resource.

Clients 306-1, 306-2, 306-3 can privatize the log data before upload to the server. Clients 306-1, 306-2, 306-3 can implement any variety of data manipulation techniques to increase privacy of the log data. Clients 306-1, 306-2, 306-3 can add noise to the log data. Clients 306-1, 306-2, 306-3 can strip the log data of any personal identifying information (e.g., any resource locators that would reveal PII). Clients 306-1, 306-2, 306-3 can opt out of participating in the training cycle.

Aggregate conversation data 308 can aggregate the logged conversation data received from participating clients. Aggregate conversation data 308 can be further privatized to adhere to one or more privacy metrics. For instance, aggregate conversation data 308 can be configured to satisfy a differential privacy metric, such that the absence of any particular client's contribution would not alter the composition of the aggregate data within an epsilon value.

Aggregate conversation data 308 can be filtered based on one or more policies. An approval policy can be used to determine whether a conversation sequence is approved for use in training data. For instance, an entity associated with a web resource can request that its web resources not be used for shortcut generation. In this manner, for instance, machine-learned model 316 (e.g., generative model 112 or 214) can be trained without reference to the conversation indicators associated with that web resource and client application 302 (e.g., client application 102 or 202) can be configured to not invoke machine-learned model 316 (e.g., generative model 112 or 214) to generate query-response pairs (e.g., facilitate a conversation interface) or generate shortcuts associated with that web resource.

Validated conversation sequences can be obtained by analysis of aggregate conversation data 308. Observed conversation sequences that appear with more frequency can be associated with successful conversations (e.g., successful obtaining of relevant information relating to one or more queries). Conversation sequences can be validated in this manner in some examples.

Training conversation sequence 310 can be drawn from aggregate conversation data 308. Training conversation sequence 310 can be sampled (e.g., randomly sampled) from aggregate conversation data 308. Training conversation sequence 310 can be obtained by sliding a window over sequential conversation indicators in aggregate conversation data 308.

The window can be configured with various sequence lengths.

Input sequence 312 can be obtained from training conversation sequence 310 by dropping, replacing, obscuring, or otherwise altering one or more of the conversation indicators in training conversation sequence 310. Machine-learned model 316 (e.g., generative model 112 or 214) can attempt to predict the missing conversation indicator based on the preceding indicators.

Trainer 314 can use the omitted or altered conversation indicator as a ground truth reference for evaluating the quality of the predictions. In this manner, for instance, the system can perform a type of self-supervised learning.

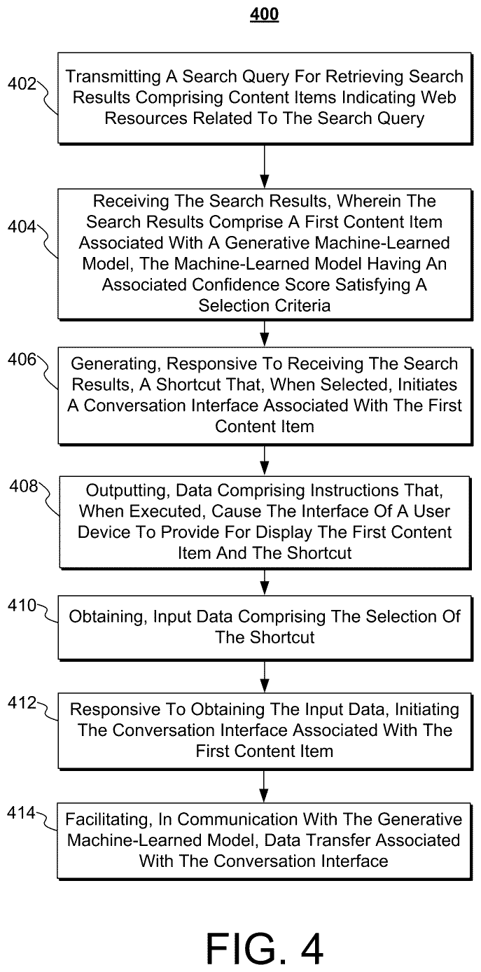

FIG. 4 depicts a flow diagram of an example method 400 to perform generative model validation to reduce hallucinations in conversation interfaces relating to content items and the generation of context tailored landing pages in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 400 is performed by a server computing system (e.g., server computing system 604) or client computing system (e.g., client computing system 602). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processors can be omitted in various embodiments. Thus, not all processes are required in every embodiment. Other process flows are possible.

At operation 402, processing logic can transmit a search query for retrieving search results comprising content items indicating web resources related to the search query. For instance, the search query can be a search term or other input provided by a user via an interface of a client device. The search query can be transmitted to a server computing system or other search retrieval component that can generate or aggregate search results relevant to the search query.

At operation 404, processing logic receives the search results. The search results can comprise a first content item associated with a generative machine-learned model having an associated confidence score satisfying a selection criteria. For instance, the search results can include a content item that is associated with a generative machine-learned model. The content item and generative machine-learned model can be associated with a domain or some other web resource. The generative machine-learned model can obtain input prompts (e.g., comprising search queries and context data) and be trained and tuned to provide output responses based on the obtained input prompts.

Additionally, or alternatively, the search results can include native search results that do not contain additional content and are selected based on a search algorithm. The one or more content items can be selected or generated by a content selection component. In some instances, content selection component can include a generative machine-learned model configured to generate customized content items to provide responsive to user queries.

As described herein, the generative machine-learned model can comprise a language model. For instance, the generative model can include a “large language model” or other machine-learned model that has been trained (e.g., through knowledge distillation from the output of a machine-learned model). The generative machine-learned model can be specifically trained or tuned to provide responses related to a specific web resource, domain, or accessible database. In some instances, the generative machine-learned model can be trained or tuned to provide responses to a plurality of web resources, domains, or accessible databases.

In some implementations the confidence score can be generated based on a model performance before being used in real-time. For instance, the performance of a model can be evaluated based on ground truth data (e.g., known input and output compared to the output generated by the model based on obtaining the known input as a prompt). Additionally, or alternatively, the confidence score can be generated based at least in part on the search query. For instance, the confidence score can be generated in near-real time and responsive to obtaining the search query. Thus, the system could perform the above-recited steps for one or more content items with associated generative machine-learned models. The system can use the plurality of generated confidence scores as an additional criterion in the content selection process. For instance, the content item selection process can include a bidding process that takes into account various selection criteria including the search query, contextual data, and content provided data. As described herein, the first content item can be selected based at least in part on a bidding process.

At operation 406, processing logic generates, responsive to receiving the search results, a shortcut that, when selected, initiates a conversation interface associated with the first content item. For instance, the processing logic can generate a selectable user interface element (e.g., a button that says “Ask more” or “Learn more”). Upon receipt of data indicative of user selection of the user interface element, the processing logic can cause a conversation interface to appear (e.g., as described in FIG. 1 and FIG. 2).

At operation 408, processing logic outputs data comprising instructions that, when executed, cause the interface of a user device to provide for display the first content item and the shortcut. For instance, the client application can be rendered for display via an interface of a client device. The first content item can be provided for display and can include one or more selectable components, natural language information, visual components, audio components, or other components.

At operation 410, processing logic obtains input data comprising the selection of the shortcut. For instance, the user can “select” the shortcut (e.g., a button).

At operation 412, processing logic initiates, responsive to obtaining the input data, the conversation interface associated with the first content item. As described above, the client application can be rendered for display via an interface of a client device. Responsive to a user selecting the shortcut, the user interface can be updated to initiate a conversation interface (e.g., a chat interface). The conversation interface can appear related to the search results. Additionally, or alternatively, the conversation interface can have a look and feel that aligns with a web resource associated with the content element (e.g., align with a content provider or publisher's branding such as color, font, linguistic style, etc.). In some instances, the conversation interface can resemble a customer service chat interface to answer more questions about the associated content item.

In some instances, the initial conversation interface can include a plurality of suggested follow-up questions. Additionally, or alternatively, the initial conversation interface can include one or more freeform input components to obtain natural language input provided by a user or third-party system providing search queries.

At operation 414, processing logic facilitates data transfer associated with the conversation interface. For instance, the processing logic can help facilitate a back-and-forth conversation between a user utilizing the client application (e.g., actively performing a search session), and the one or more generative machine-learned models. Thus, the present disclosure provides for a generative machine-learned model (e.g., language model) powered chat interface for obtaining answers to follow-up questions associated with a content item.

Facilitating data transfer associated with the conversation interface can include providing, to the generative machine-learned model, an input prompt comprising the search query and the context data. The context data can include one or more prior search queries provided within a predetermined amount of time of the received search query, prior search session data, location data, or recent search actions.

For instance, a user can perform a few searches relating to cell phone, wireless, or cable searches. Some search queries could include questions about pricing, some could include a location for the desired services. The processing logic can obtain a most recent search query (e.g., “wireless service in my area”) and context data (e.g., data associated with a location, a search for additional services such as cell phone or cable, and the like).

Facilitating data transfer associated with the conversation interface can include obtaining, from the generative machine-learned model, output data comprising an initial response to the input prompt. For instance, in the example described above, the generative machine-learned model can provide one or more suggested follow-up queries (e.g., cost of services in my area, cost of services in City A, and the like). As described herein, the initial response can include at least one of a recommended follow-up search query or a message indicating a request for input of a follow-up query. For instance, the response provided as output from the model can include an interactive user interface element for obtaining user input (e.g., via a free form input field). Facilitating data transfer associated with the conversation interface can include providing, via the conversation interface, the initial response for display.

In some implementations, the facilitating the data transfer associated with the conversation interface can include obtaining a second follow-up search query. For instance, continuing with the example above, the follow-up search query could be “what is the cost?”.

The processing logic can generate an input prompt comprising the search query and the context data. For instance, the processing logic can generate an input prompt data structure (e.g., via prompt engineering) to include the current query (e.g., “what is the cost?”) but also additional context data associated with the previous search queries, or in some cases previous query and responses within the conversation interface (e.g., indicating the known data such as location, types of services, and the like).

The search query can be used for monitoring and analyzing the generative machine-learned model's performance (e.g., model tracking). This can allow for analyzing input and the input's performance overtime. This can allow the present system to improve on input prompt generation to generate better output. The tracking can be performed using a feedback loop and based on the feedback, the generative machine-learned model and can finetuned to improve the performance.

In some instances, the search query, or terms within the search query, can be assigned to identifiers or keywords. The identifiers, keywords, or search query can be stored alongside the output for tracking purposes as described herein.

The search query can be provided as input alongside the context data to provide additional information to be used as input into the generative machine-learned model. For instance, a search query for “gray luxury SUV” and “used car” can both result in display of a content item associated with a car dealership. However, upon selection of an “ask more” button, the initial conversation interface for each query can be different. For instance, a suggested follow-up question for the “gray luxury SUV” could be “what cars are currently available with five seats” and a suggested follow-up question for “used car” could be “what cars do you have with under 30,000 miles?”

The processing logic can provide to the generative machine-learned model, the second input data structure. The processing logic can obtain from the generative machine-learned model, a second response. The second response can be generated based on the input prompt and the parsed web resource associated with the first content item. The second response can be generated as discussed above with the query and context data informing the model on additional context for the query being provided.

In some implementations, the processing logic can obtain a response indicating that the generative machine-learned model is unable to provide an accurate response to the second follow-up search query. For instance, the generative machine-learned model can be trained and associated with a wireless service provider. Thus, a question relating to the cost of a cat food that is unrelated to the wireless service provider would likely not be a good candidate query for the generative machine-learned model to process and provide a response to. Thus, the processing logic can determine the inability to provide a response and can generate a message indicating that the query is outside of an answerable domain or some other indication that a response to the query cannot be provided.

The processing logic can provide via the conversation interface, the second response for display. For instance, in some instances, the second response for display can include a natural language message providing an answer to a question. Additionally, or alternatively, the processing logic can, based on the obtained response, generate a message comprising an indication that the second follow-up search query cannot be answered and a shortcut to a web resource associated with the first content item cannot be provided. The processing logic can include providing, via the conversation interface, the generated message.

In some implementations, facilitating the data transfer associated with the conversation interface can include validating the second response. By way of example, facilitating the data transfer associated with the conversation interface can include, responsive to validating the second response, providing, via the conversation interface, the second response for display. For instance, a validation process can occur in real-time. The validation can determine an estimated or predicted accuracy of response data. Responsive to determining that the response is validated, the response can be provided via the conversation interface. Alternatively, if the response is not validated, a message indicating low confidence and requesting a new search query or initial of a new search session can occur.

Processing logic can include generating a training dataset. For instance, the processing logic can generate a training dataset by generating a data structure comprising a summary of the input prompt data and output data. In some implementations, processing logic can generate training data based on the context data associated with the conversation interface. As described herein, the processing logic can perform an external validation process to assess an accuracy of one or more input prompt-response pairs generated by the machine-learned model. Using the externally validated input prompt-response pairs, the processing logic can determine a confidence score associated with the generative machine-learned model.

The processing logic can include training the generative machine-learned model based on the training data. As described herein, training the generative machine-learned model can include comparing the output data to a parsed known ground truth dataset associated with a web resource or a dataset of reviewed answers. For instance, datasets can be generated based on validation or review by a third-party application, system, component, or user.

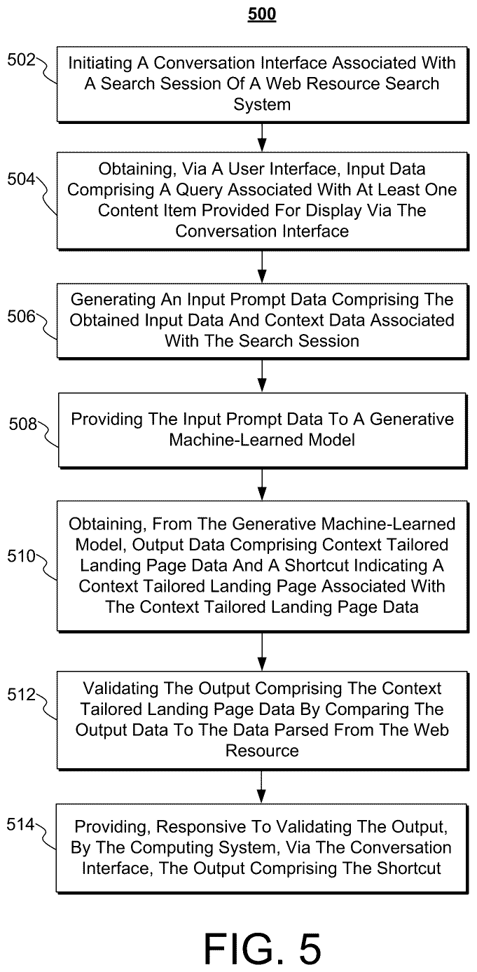

FIG. 5 depicts a flow diagram of an example method 500 to perform generative model validation to reduce hallucinations in conversation interfaces relating to content items and the generation of context tailored landing pages in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 500 is performed by a server computing system (e.g., server computing system 604) or client computing system (e.g., client computing system 602). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processors can be omitted in various embodiments. Thus, not all processes are required in every embodiment. Other process flows are possible.

At operation 502, processing logic initiates a conversation interface associated with a search session of a web resource search system. For instance, a conversation interface associated with a search session can include a back-and-forth data transfer wherein a user provides one or more queries and a generative machine-learned model (e.g., a large language model) provides answers alongside search results (e.g., sources) which can provide additional information relating to the answers.

At operation 504, processing logic obtains input data comprising a query associated with at least one content item provided for display via the conversation interface. As described herein, the at least one content item can be selected based on a bidding process. For instance, the content item can be associated with a search query but also selected by a content selection component. In some instances, one or more content providers can set preferences for selection criteria to allow for better utilization of resources and limited display area.

At operation 506, processing logic generates input prompt data comprising the obtained input data and context data associated with the search session. As described herein, the context data can include one or more prior search queries, prior query-response pair data, location data, or other logged data. The generated input prompt data can include taking the search query and context data and performing a prompt engineering process to package the data in a manner to receive better-than-average output from the generative machine-learned model.

At operation 508, processing logic provides the input prompt data to a generative machine-learned model. As described herein, the generative machine-learned model can include a language model. For instance, the language model can include a large language model. As described herein, the generative machine-learned model can be a neural network or other machine-learned model capable of obtaining natural language input prompts (e.g., questions) and providing responses as output (e.g., answers, additional information, generated content items, generated code, generated customized landing pages, and the like). The generative machine-learned models can be trained to perform certain tasks or become experts in certain areas. For instance, the generative machine-learned model can become an expert in generating context tailored landing pages.

At operation 510, processing logic obtains output data comprising context tailored landing page data and a shortcut indicating a context tailored landing page associated with the context tailored landing page data. As described herein, the output is generated based at least in part on the generative machine-learned model parsing a web resource associated with the at least one content item. For instance, as depicted in FIG. 2, the system can parse a web resource (e.g., web resource 210) to obtain data about the web resource (e.g., services offered, current pricing, location, hours, and the like). The context tailored landing page can determine, based on the input prompt, what data is most relevant to the query. IN response, the context tailored landing page can include the most relevant data in more visually (or otherwise) prominently placed content element locations.

As described herein, the context tailored landing page data can include an HTTPs request which can be obtained by a web resource. In response, the web resource can generate the context tailored landing page. The context tailored landing page can include one or more visual indicators associated with the input prompt data. The context tailored landing page can be presented in such a way to orient a viewer to the relevant data associated with the web resource that a non-context tailored landing page can exclude. Thus, the context tailored landing page can allow for more efficient use of display space and prevent extensive journeys through a web resource and connected pages by providing more relevant information automatically by generating and presenting the context tailored landing page.

In some implementations, the processing logic can generate the context tailored landing page based at least in part on a landing page template. For instance, a publisher or other entity associated with a web resource can generate a template. The generative machine-learned model can generate an output data structure that is compatible with the landing page template. In some implementations, a generative machine-learned model can generate the landing page template.

In some implementations, the shortcut can be configured to cause the context tailored landing page to be provided for display responsive to selection of the shortcut. For instance, selection of the shortcut can cause the data associated with the context tailored landing page to be transmitted such that the client application state is updated to provide for display the context tailored landing page. In some instances, this can include triggering context tailored landing page data to be transmitted to a domain associated with a web resource. The domain can, responsive to obtaining the context tailored landing page data, generate a context tailored landing page to be provided for display.

At operation 512, processing logic validates the output comprising the context tailored landing page data by comparing the output data to data parsed from the web resource. As described herein, the processing logic can determine an accuracy of the context tailored landing page data. Responsive to determining that the accuracy satisfies a selection criteria, the custom landing page can be provided for display. If however, the processing logic determines that the accuracy of the context tailored landing page data does not satisfy a selection criteria, the computing system can prevent the transmittal of the context tailored landing page data or generate an updated shortcut or URL that, upon selection, updates a client application state to display a website's default landing page.

At operation 514, processing logic provides, via the conversation interface, the output comprising the shortcut. As described herein, the shortcut can be provided for display via the conversation interface as a selectable interface element. The processing logic can obtain data indicative of the user's selection of the shortcut. Responsive to the user selection of the shortcut, the client application state can be updated (e.g., as depicted in FIG. 2) to provide for display the context tailored landing page.

In an example aspect, the present disclosure provides for an example system for prompt element generation for use as input in generative models, including one or more processors and one or more memory devices storing instructions that are executable to cause the one or more processors to perform operations. In some implementations, the one or more memory devices can include one or more transitory or non-transitory computer-readable media storing instructions that are executable to cause the one or more processors to perform operations. In the example system, the operations can include initiating a conversation interface associated with a search session of a web resource search system. In the example system, the operations can include obtaining, via a user interface, input data comprising a query associated with at least one content item provided for display via the conversation interface. In the example system, the operations can include generating, input prompt data comprising the obtained input data and context data associated with the search session. In the example system, the operations can include providing the input prompt data to a generative machine-learned model. In the example system, the operations can include obtaining, from the generative machine-learned model, output data comprising context tailored landing page data and a shortcut indicating a context tailored landing page associated with the context tailored landing page data. The output can be generated based at least in part on the generative machine-learned model parsing a web resource associated with the at least one content item. In the example system, the operations can include validating the output comprising the context tailored landing page data by comparing the output data to the data parsed from the web resource. In the example system, the operations can include providing, responsive to validating the output, via the conversation interface, the output comprising the shortcut.

In the example system, the context tailored landing page data comprises an HTTPs request which can be obtained by a web resource, and in response, the web resource will generate the context tailored landing page, wherein the context tailored landing page comprises one or more visual indicators associated with the input prompt data.

In the example system, the context tailored landing page is generated based at least in part on a landing page template.

In the example system, the shortcut is configured to cause the context tailored landing page to be provided for display responsive to selection of the shortcut.

In the example system, the context data comprises one or more prior search queries, prior query-response pair data, location data, or log data.

In the example system, the generative machine-learned model comprises a language model.

In the example system, the at least one content item is selected based on a bidding process.

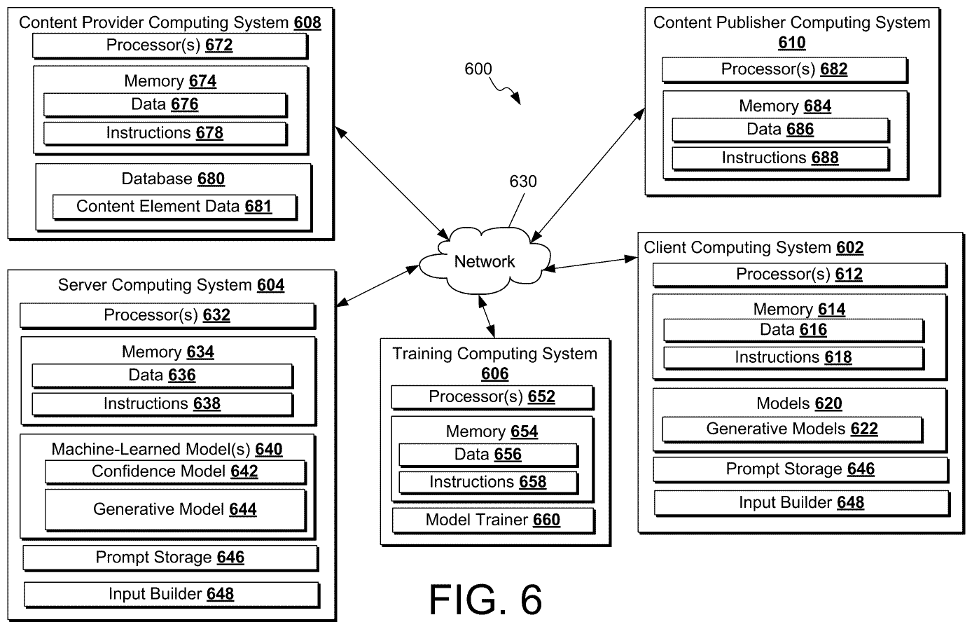

FIG. 6 depicts a block diagram of an example computing system 600 that performs prompt generation and recommendations for input into generative models to improve the output of the generative models according to example embodiments of the present disclosure.

The computing system 600 includes a client computing system 602, a server computing system 604, a training computing system 606, a content provider computing system 608, and a content publisher computing system 610 that are communicatively coupled over a network 630.

The client computing system 602 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The client computing system 602 includes one or more processors 612 and a memory 614. The one or more processors 612 can be any suitable processing device (e.g., a processor core, a microprocessor, an ASIC, an FPGA, a controller, a microcontroller, etc.) and can be one processor or a plurality of processors that are operatively connected. The memory 614 can include one or more non-transitory computer-readable storage media, such as RAM, ROM, EEPROM, EPROM, flash memory devices, magnetic disks, etc., and combinations thereof. The memory 614 can store data 616 and instructions 618 which are executed by the processor 612 to cause the client computing system 602 to perform operations.

In some implementations, the client computing system can include an application.

The application can include an application that is downloaded on a user device. Additionally, or alternatively, the application can include a web-based application. The application can communicate with an application programming interface to interface with a search system. For instance, the API can facilitate interaction between client computing system 602, server computing system 604, and content publisher computing system 610.

In some implementations, the client computing system can include a user interface. The user interface can include a graphical user interface, audio user interface, touch user interface, or any other user interface. The client computing system can include a user input component. The user input component can be associated with user interface and can be capable of obtaining user input. For instance, user input can include touch, audio, or other user input. In some instances, user input component can be capable of obtaining user input and translating the user input into a computer readable form.

As described above, the client computing system 602 can store or otherwise include one or more models 620 (e.g., generative model 622). For example, the models 620 (e.g., generative models 622) can be or can otherwise include various statistical or machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Models 620 can include generative models 622.

Generative models 622 can be configured to generate one or more output prompts responsive to obtaining input prompt data. The output prompts can include, for example, responses to user search queries, follow-up questions, or context tailored landing page data. The confidence model 642 and generative model 622 are discussed with reference to FIG. 1 and FIG. 2.

The client computing system 602 or the server computing system 604 can train the models 620, 640 via interaction with the training computing system 606 that is communicatively coupled over the network 630. The training computing system 606 can be separate from the server computing system 604 or can be a portion of the client computing system 602.

Client computing system 602 or server computing system 604 can include prompt storage 646 or input builder 648. Prompt storage 646 can include prompt data. For instance, prompt storage 646 can include previous input prompt data. Input builder 648 can be configured to generate input prompt data to use as input into one or more generative models e.g., generative model 644, 622, and the like).

The server computing system 604 includes one or more processors 632 and a memory 634. The one or more processors 632 can be any suitable processing device (e.g., a processor core, a microprocessor, an ASIC, an FPGA, a controller, a microcontroller, etc.) and can be one processor or a plurality of processors that are operatively connected. The memory 634 can include one or more non-transitory computer-readable storage media, such as RAM, ROM, EEPROM, EPROM, flash memory devices, magnetic disks, etc., and combinations thereof. The memory 634 can store data 636 and instructions 638 which are executed by the processor 632 to cause the server computing system 604 to perform operations.

In some implementations, the server computing system 604 includes or is otherwise implemented by one or more server computing devices. In instances in which the server computing system 604 includes plural server computing devices, such server computing devices can operate according to sequential computing architectures, parallel computing architectures, or some combination thereof.

Server computing system 604 can be configured to obtain data from client computing system 602 (e.g., via an application). For instance, server computing system 604 can utilize the obtained user input data to update or train one or more models 620 or 640 (e.g., confidence model 642, generative model 644, generative model 622).

As described above, the server computing system 604 can store or otherwise include one or more models 640 (e.g., confidence model 642, generative model 644, generative model 622). For example, the models 640 (e.g., confidence model 642, generative model 644, generative model 622) can be or can otherwise include various statistical or machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Models 640 can include confidence model 642 and generative model 644. Confidence model 642 can determine a confidence level in a generative model's accuracy. Generative model 644 can be configured to generate one or more output prompts responsive to obtain input prompt data. The output prompts can include, for example, responses to user search queries, follow-up questions, or context tailored landing page data. The confidence model 642 and generative model 644 are discussed with reference to FIG. 1 and FIG. 2.

The content provider computing system 608 includes one or more processors 672 and a memory 674. The one or more processors 672 can be any suitable processing device (e.g., a processor core, a microprocessor, an ASIC, an FPGA, a controller, a microcontroller, etc.) and can be one processor or a plurality of processors that are operatively connected. The memory 674 can include one or more non-transitory computer-readable storage media, such as RAM, ROM, EEPROM, EPROM, flash memory devices, magnetic disks, etc., and combinations thereof. The memory 674 can store data 676 and instructions 678 which are executed by the processor 672 to cause the content provider computing system 608 to perform operations.

In some implementations, the content provider computing system 608 includes or is otherwise implemented by one or more server computing devices. In instances in which the content provider computing system 608 includes plural server computing devices, such server computing devices can operate according to sequential computing architectures, parallel computing architectures, or some combination thereof.

Content provider computing system 608 can include database 680. Database 680 can store content element data 681. Content element data 681 can include content elements, asset groups, or other content related data.

Content provider computing system 608 can be communicatively connected over network 630 to server computing system 604. In some instances, content provider computing system 608 can be a first party computing system associated with the server computing system 604. In some instances, content provider computing system 608 can be associated with a third-party content provider (e.g., advertiser). There can be more than one content provider computing system 608.

The content publisher computing system 610 includes one or more processors 682 and a memory 684. The one or more processors 682 can be any suitable processing device (e.g., a processor core, a microprocessor, an ASIC, an FPGA, a controller, a microcontroller, etc.) and can be one processor or a plurality of processors that are operatively connected. The memory 684 can include one or more non-transitory computer-readable storage media, such as RAM, ROM, EEPROM, EPROM, flash memory devices, magnetic disks, etc., and combinations thereof. The memory 684 can store data 686 and instructions 688 which are executed by the processor 682 to cause the content publisher computing system 610 to perform operations.

In some implementations, the content publisher computing system 610 includes or is otherwise implemented by one or more server computing devices. In instances in which the content publisher computing system 610 includes plural server computing devices, such server computing devices can operate according to sequential computing architectures, parallel computing architectures, or some combination thereof.

The training computing system 606 includes one or more processors 652 and a memory 654. The one or more processors 652 can be any suitable processing device (e.g., a processor core, a microprocessor, an ASIC, an FPGA, a controller, a microcontroller, etc.) and can be one processor or a plurality of processors that are operatively connected. The memory 654 can include one or more non-transitory computer-readable storage media, such as RAM, ROM, EEPROM, EPROM, flash memory devices, magnetic disks, etc., and combinations thereof. The memory 654 can store data 656 and instructions 658 which are executed by the processor 652 to cause the training computing system 606 to perform operations. In some implementations, the training computing system 606 includes or is otherwise implemented by one or more server computing devices.

The training computing system 606 can include a model trainer 660 that trains the machine-learned models 620, 640 stored at the client computing system 602, the server computing system 604, the content provider computing system 608, or the content publisher computing system 610 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, or various other loss functions. Gradient descent techniques can be used to iteratively update the parameters over a number of training iterations.

In some implementations, performing backwards propagation of errors can include performing truncated backpropagation through time. The model trainer 660 can perform a number of generalization techniques (e.g., weight decays, dropouts, etc.) to improve the generalization capability of the models being trained.

In particular, the model trainer 660 can train the models 620, 640 based on a set of training data. The training data can include, for example, historic signal data, publisher-rendered native content item data, user input data, conversion data, user device location data, click data, or any other relevant data (e.g., data stored in database 680, data stored in prompt storage 646, and the like).

In some implementations, if the user has provided consent, the training examples can be provided by the client computing system 602. Thus, in such implementations, the models 620, 640 provided to the client computing system 602 can be trained by the training computing system 606 on user-specific data received from the client computing system 602.

In some instances, this process can be referred to as personalizing the model.

The model trainer 660 includes computer logic utilized to provide desired functionality. The model trainer 660 can be implemented in hardware, firmware, or software controlling a general purpose processor. For example, in some implementations, the model trainer 660 includes program files stored on a storage device, loaded into a memory and executed by one or more processors. In other implementations, the model trainer 660 includes one or more sets of computer-executable instructions that are stored in a tangible computer-readable storage medium such as RAM, hard disk, or optical or magnetic media.

The network 630 can be any type of communications network, such as a local area network (e.g., intranet), wide area network (e.g., Internet), or some combination thereof and can include any number of wired or wireless links. In general, communication over the network 630 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

The machine-learned models described in this specification may be used in a variety of tasks, applications, or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data, and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data.

In some cases, the task comprises a microprocessor performance task, such as branch prediction or memory address translation.

FIG. 6 illustrates one example computing system that can be used to implement the present disclosure. Other computing systems can be used as well. For example, in some implementations, the client computing system 602 can include the model trainer 660 and the training data. In such implementations, the models 620, 640 can be both trained and used locally at the client computing system 602. In some of such implementations, the client computing system 602 can implement the model trainer 660 to personalize the models 620, 622 based on user-specific data.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

The depicted or described steps are merely illustrative and can be omitted, combined, or performed in an order other than that depicted or described; the numbering of depicted steps is merely for ease of reference and does not imply any particular ordering is necessary or preferred.

The functions or steps described herein can be embodied in computer-usable data or computer-executable instructions, executed by one or more computers or other devices to perform one or more functions described herein. Generally, such data or instructions include routines, programs, objects, components, data structures, or the like that perform particular tasks or implement particular data types when executed by one or more processors in a computer or other data-processing device. The computer-executable instructions can be stored on a computer-readable medium such as a hard disk, optical disk, removable storage media, solid-state memory, read-only memory (ROM), random-access memory (RAM), or the like. As will be appreciated, the functionality of such instructions can be combined or distributed as desired. In addition, the functionality can be embodied in whole or in part in firmware or hardware equivalents, such as integrated circuits, application-specific integrated circuits (ASICs), field-programmable gate arrays (FPGAs), or the like. Particular data structures can be used to implement one or more aspects of the disclosure more effectively, and such data structures are contemplated to be within the scope of computer-executable instructions or computer-usable data described herein.

Although not required, one of ordinary skill in the art will appreciate that various aspects described herein can be embodied as a method, system, apparatus, or one or more computer-readable media storing computer-executable instructions. Accordingly, aspects can take the form of an entirely hardware embodiment, an entirely software embodiment, an entirely firmware embodiment, or an embodiment combining software, hardware, or firmware aspects in any combination.

As described herein, the various methods and acts can be operative across one or more computing devices or networks. The functionality can be distributed in any manner or can be located in a single computing device (e.g., server, client computer, user device, or the like).

Aspects of the disclosure have been described in terms of illustrative embodiments thereof. Numerous other embodiments, modifications, or variations within the scope and spirit of the appended claims can occur to persons of ordinary skill in the art from a review of this disclosure. For example, one or ordinary skill in the art can appreciate that the steps depicted or described can be performed in other than the recited order or that one or more illustrated steps can be optional or combined. Any and all features in the following claims can be combined or rearranged in any way possible.

Aspects of the disclosure have been described in terms of illustrative embodiments thereof. Numerous other embodiments, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, or equivalents to such embodiments. Accordingly, the subject disclosure does not preclude inclusion of such modifications, variations, or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, or equivalents.

1. A computer-implemented method, the method comprising:
transmitting, by a computing system and to a search system, a search query for retrieving search results comprising content items indicating web resources related to the search query;
receiving, by the computing system and from the search system, the search results, wherein the search results comprise a first content item associated with a generative machine-learned model, wherein the first content item was selected based at least in part on the machine-learned model having an associated confidence score satisfying a selection criteria;
generating, by the computing system, responsive to receiving the search results, a shortcut that, when selected, initiates a conversation interface associated with the first content item;
outputting, by the computing system, data comprising instructions that, when executed, cause the interface of a user device to provide for display the first content item and the shortcut;
obtaining, by the computing system, input data comprising the selection of the shortcut; and
responsive to obtaining the input data, initiating the conversation interface associated with the first content item.

2. The computer-implemented method of claim 1, comprising:
facilitating, by the computing system in communication with the generative machine-learned model, data transfer associated with the conversation interface by:
providing, by the computing system to the generative machine-learned model, an input prompt comprising the search query and context data;
obtaining, from the generative machine-learned model, output data comprising an initial response to the input prompt; and
providing, by the computing system, via the conversation interface, the initial response for display.

3. The computer-implemented method of claim 2, wherein the initial response comprises at least one of a recommended follow-up search query or a message indicating a request for input of a follow-up query.

4. The computer-implemented method of claim 2, wherein facilitating the data transfer associated with the conversation interface comprises:
obtaining, by the computing system, a second follow-up search query;
generating, by the computing system, a second input data structure comprising the input data prompt, the initial response, and the second follow-up search query;
providing, by the computing system, to the generative machine-learned model the second input data structure;
obtaining, by the computing system from the generative machine-learned model, a second response, wherein the second response is generated based on the input prompt and a parsed web resource associated with the first content item; and
providing, by the computing system, via the conversation interface, the second response for display.

5. The computer-implemented method of claim 4, wherein facilitating the data transfer associated with the conversation interface comprises:
validating, by the computing system, the second response; and
responsive to validating the second response, providing, by the computing system, via the conversation interface, the second response for display.

6. The computer-implemented method of claim 4, wherein the second response comprises a context tailored landing page data and a shortcut indicating a context tailored landing page associated with the context tailored landing page data, wherein the output is generated based at least in part on the generative machine-learned model parsing a web resource associated with the first content item.

7. The computer-implemented method of claim 6, wherein the context tailored landing page data comprises an HTTPs request which can be obtained by a web resource, and in response, the web resource will generate the context tailored landing page, wherein the context tailored landing page comprises one or more visual indicators associated with the input prompt data.

8. The computer-implemented method of claim 6, wherein the context tailored landing page is generated based at least in part on a landing page template.

9. The computer-implemented method of claim 6, wherein the shortcut is configured to cause the context tailored landing page to be provided for display responsive to selection of the shortcut.

10. The computer-implemented method of claim 2, comprising:
generating a training dataset by generating a data structure comprising a summary of the input prompt and the output data; and
training the generative machine-learned model based on the training data.

11. The computer-implemented method of claim 2, wherein facilitating the data transfer comprises:
obtaining, by the computing system, a second follow-up search query;
generating, by the computing system, a second input data structure comprising the input data prompt, the initial response, and the second follow-up search query;
providing, by the computing system, to the generative machine-learned model the second input data structure;
obtaining, by the computing system, from the generative machine-learned model, a response indicating that the generative machine-learned model is unable to provide an accurate response to the second follow-up search query;
based on the obtained response, generating a message comprising an indication that the second follow-up search query cannot be answered and a shortcut to a web resource associated with the first content item cannot be provided; and
providing, by the computing system, via the conversation interface, the generated message.

12. The computer-implemented method of claim 2, comprising:
generating training data based on the context data and data associated with the conversation interface; and
comparing the output to a parsed known ground truth web resource or one or more reviewed answers.

13. The computer-implemented method of claim 12, wherein generating the training data based on the context data and the data associated with the conversation interface comprises:
performing an external validation process to assess an accuracy of one or more input prompt-response pairs generated by the generative machine-learned model; and
using the externally validated input prompt-response pairs to determine a confidence score associated with the generative machine-learned model.

14. The computer-implemented method of claim 2, wherein the first content item is selected based at least in part on a bidding process.

15. The computer-implemented method of claim 2, wherein the generative machine-learned model comprises a language model.

16. The computer-implemented method of claim 2, wherein the confidence score is generated based at least in part on the search query.

17. The computer-implemented method of claim 16, wherein the confidence score is generated in near real-time.

18. The computer-implemented method of claim 2, wherein the context data comprises one or more prior search queries provided within a predetermined amount of time of the received search query, prior search session data, location data, or recent search actions.

19. A computing system, comprising:
one or more processors; and
one or more non-transitory computer-readable media storing instructions that are executable to cause the one or more processors to perform operations, the operations comprising:
transmitting, by a computing system and to a search system, a search query for retrieving search results comprising content items indicating web resources related to the search query;
receiving, by the computing system and from the search system, the search results, wherein the search results comprise a first content item associated with a generative machine-learned model, wherein the first content item was selected based at least in part on the machine-learned model having an associated confidence score satisfying a selection criteria;
generating, by the computing system, responsive to receiving the search results, a shortcut that, when selected, initiates a conversation interface associated with the first content item;
outputting, by the computing system, data comprising instructions that, when executed, cause the interface of a user device to provide for display the first content item and the shortcut;
obtaining, by the computing system, input data comprising the selection of the shortcut; and
responsive to obtaining the input data, initiating the conversation interface associated with the first content item.

20. One or more non-transitory computer readable media storing instructions that are executable by one or more processors to perform operations comprising:
transmitting, by a computing system and to a search system, a search query for retrieving search results comprising content items indicating web resources related to the search query;
receiving, by the computing system and from the search system, the search results, wherein the search results comprise a first content item associated with a generative machine-learned model, wherein the first content item was selected based at least in part on the machine-learned model having an associated confidence score satisfying a selection criteria;
generating, by the computing system, responsive to receiving the search results, a shortcut that, when selected, initiates a conversation interface associated with the first content item;
outputting, by the computing system, data comprising instructions that, when executed, cause the interface of a user device to provide for display the first content item and the shortcut;
obtaining, by the computing system, input data comprising the selection of the shortcut; and
responsive to obtaining the input data, initiating the conversation interface associated with the first content item.
